(19) United States
(12) Patent Application Publication
(10) Pub. No.: US 2018/0143754 A1
(43) Pub. Date: May 24, 2018

(54) VEHICLE STEERING AND CONTROL DEVICE (VSCD)

(71) Applicant: Sarfaraz K. Niazi, Deerfield, IL (US)

(72) Inventor: Sarfaraz K. Niazi, Deerfield, IL (US)

(21) Appl. No.: 15/359,384

(22) Filed: Nov. 22, 2016

(51) Int. Cl. G06F 3/0488; B60K 35/00; B60R 1/00; G06F 3/0481; G06F 3/0484; G06K 9/00

(52) U.S. Cl. CPC G06F 3/0488; B60R 2300/105; B60R 1/00; G06F 3/04817; G06F 3/04847; G06K 9/00288; B60K 2350/1004; B60K 2350/1028; B60K 2350/2034; B60K 2350/2013; B60R 2300/102; B60R 2300/802; B60K 2350/2069; B60K 2350/928; B60K 35/00

(57) ABSTRACT

A steering and vehicle control device comprising a flat touch-sensitive electronic screen serving as a steering wheel and as a graphic user interface (GUI) to control operations of a vehicle by touching the screen.

### BACKGROUND OF THE INVENTION

This invention relates to the technical field of the design and function of a steering wheel comprising a flat touch-sensitive electronic screen that also serves the function of a graphic user interface to control vehicle functions.

### BRIEF SUMMARY OF THE INVENTION

The present invention is a flat electronic display screen performing the function of a steering device wherein a screen displays vehicle operational conditions as well as icons to control the vehicle. The steering device can be operated within a vehicle or from a remote location to allow a vehicle to be operated from a distance. This design change in customary steering wheel devices provides numerous safety, security, and economy in the use of vehicles.

A touch-sensitive steering wheel can read out vehicle conditions as well as control of all vehicle functions converted to digital control. Use of a single screen removes the need to turn a head or take hands off the steering wheel while operating a vehicle. Removing the steering device from the automobile provides additional security and using a removed steering device allows for full remote control managed by humans at a distance. This summary of the invention does not necessarily describe all features of the invention.

### BRIEF DESCRIPTION OF THE SEVERAL VIEWS OF THE DRAWING

The features of the invention enumerate above and below will become more apparent from the following description in which reference is made to the appended drawing wherein:

FIG. 1A shows a front view of the screen visible to the vehicle driver.

FIG. 1B shows a perspective view of the back of the screen with a grip element attached to the edge of the screen.

FIG. 1C shows a perspective view of the back of the screen with a mechanical or motorized boss connect the screen to a stationary surface without the grip element.

FIG. 1D shows a front view of the screen with a grip portion and controls provided as an example only.

### DETAILED DESCRIPTION OF THE INVENTION

A description of prior art would be steering wheels that embody controls to manage vehicle operation, electronic displays disposed of in a vehicle for navigation, entertainment and displaying operational conditions, and remote connecting controllers for moving objects.

A steering wheel is an essential part of any vehicle to maneuver the vehicle on the road; generally, it is a circular element, though several alternate shapes have been used, and connected to a steering column through a boss that connects it to a spoke portion holding a grip portion, to turn the wheels. This function of the steering wheel has remained the same for over a hundred years to turn wheels using a rotation of a tubular wheel in the hands of the driver. Recently, the steering wheels have begun including a few mechanical controls for a limited number of functions, leaving most essential controls requiring a driver to take hands off the steering wheel to operate and to turn head to see the vehicle condition displays.

There is an unmet need to turn the steering wheel into a more useful device. The instant invention replaces the traditional tubular steering wheel with a flat touch-sensitive electronic screen that can be rotated to perform the same function as a traditional steering wheel. Being an electronic device capable of displaying an icon of a steering wheel on its surface that can be manipulated by touch control, the instant invention allows as an alternative, the steering wheel to remain stationary and rotate wheels by touching the icon of a steering wheel on the screen and sending a signal to a motorized boss to connect with the steering column. This feature of the invention now allows a driver to remove the steering wheel from the vehicle and operate it remotely, giving complete control of a vehicle from a distance.

Even when the remote control is not intended, the removal of the steering wheel from the vehicle makes the vehicle inoperable as a theft-deterrent.

By consolidating controls of the vehicle within the steering wheel and allowing rearrangement of the position of displays on the screen as desired satisfies the needs of handedness as well as easy modification of a vehicle from a left-hand drive vehicle to a right-hand drive vehicle.

Allowing the controls to be near to human eye and removing the need to move the head or take hands off the steering wheel to operate controls significantly improves the safety in driving.

By consolidating all surrounding views in a panoramic display using cameras that are far more sensitive than the human eye, particularly in the foul weather and in the darkness, the safety of the vehicle is significantly improved. By using infrared cameras to display the surrounding views, it is now possible to detect humans and animals on the road that may not otherwise be visible to the naked eye, further enhancing the safety features of the vehicle to prevent accidents.

The electronic display provided in the instant invention can be rearranged to a user-preferred configuration to make it more convenient and therefore safer, more particularly to the meet need of the handedness of drivers.

The electronic screen can serve additional functions, more particularly, in enhancing the security of operations. A finger=print recognition system and a face recognition technology embedded in the front display will significantly enhance security and allow keyless operation of vehicles. The face recognition can be based prerecorded images through a camera disposed of in the front display

The electronic display of the instant invention can display information in any language, making vehicles universally useful without the need for several versions; by removing controls including rear view mirrors, the instant invention reduces the cost of repairs of broken mirrors; by introducing a face recognition feature embedded in the steering device, the instant invention allows a keyless system that is capable of identifying the driver for record keeping and legal witness; by transferring all controls to a single screen, which receives signal from a vehicle computer, the instant invention makes it possible to operate the vehicle remotely by connecting the vehicle computer to a remote station wirelessly such as through an Internet protocol; by providing a screen for display, the instant invention eliminates the need for a printed manual to accompany a vehicle as it can be stored in the vehicle computer; by digitizing all functional controls and displays, the instant invention reduces the carbon footprint of vehicles; by providing a touch-screen control, the instant invention allows presentation of mechanical steering wheel as a virtual steering wheel that is controlled by sliding fingers over a touch-sensitive edge; by providing means of optimizing the illumination of the screen, the instant invention allows view of screen without glaring the eyes of the driver; by providing a completely digital solution to all controls of a vehicle, the instant invention eliminates obsolescence of design as the computer and its firmware can be updated as needed; by reducing the need to turn head to operate vehicle, the instant invention allows drivers who have physical disability such wearing a neck harness or missing legs, to operate the vehicle; by removing the need to take hands off the steering wheel, the instant invention improves the safety of driving; by replacing rear view mirrors with cameras with night and thermal vision, the instant invention improves vision and warning systems; by removing the traditional internal rearview mirror, and combining the images from several cameras, the instant invention provides a panoramic view of the surroundings to improve safety; by allowing the steering device to be located remotely, the instant invention allows safe driving by drivers situated across the globe, reducing the cost of vehicle operation by allowing the display to remain horizontally aligned when the steering device is rotated, the instant invention significantly improves continuous view of operational conditions upon turning the steering wheel.

A review of the relevant prior art reveals that there exists a need to take an innovative approach to improving the safety of driving and security of vehicles. The instant invention includes several inventive steps, heretofore not recognized and implemented.

To improve the safety, comfort, and efficiency of driving, many mechanical and electronic functions are installed in modern vehicles; control of these functions requires complicated operations. The functionality elements of the modern vehicles have evolved over a period of over hundred years, and while the functionality of the modern vehicle has transformed significantly, the control methods remain the same, by providing buttons, knobs, dials, and levers that are scattered throughout the vehicle, in the steering column, in the central console, on the floor, in the doors, in the ceiling, in the visor, in the seats, in the in-vehicle rear-view mirror, the outside rearview mirrors, to identify a few locations, all requiring the vehicle driver to turn the head to examine the control screens and take hands off the steering wheel during vehicle operation to adjust controls. Both requirements distract vehicle driver resulting in accidents with losses of billions of dollars and precious lives.

Consolidating all or majority of controls in a vehicle to a centralized touch-sensitive screen will result in eliminating all or majority of knobs, buttons, dials, pedals and levers and additionally, allow control by touching the screen without taking hands off the steering wheel. The position of the screen is critical to the efficiency of operation and safety of vehicle driver. While a few controls have been provided in the steering wheel in modern vehicles, there is no prior art on disposing of all or most of the controls of a vehicle in the steering wheel with touch control adjustments.

Being a part of the steering device, the screen rotates rotate as the steering wheel is rotated and while this may not be of any serious safety concern, the disclosed invention allows for means to keep the screen horizontally aligned even if the steering wheel is rotated.

Recently, the art of driver-less vehicles has become evident; however, it has been determined that while the technology for the vehicle to operate itself is available, the complexity of road conditions, road signs, erratic drivers on the road, and weather condition considerations have kept this art out of full practice. There is still a need for human interaction in driving vehicles; the responsiveness of human has yet to be replicated by a computer. While, remote operation of vehicles and other objects is routinely practiced such as in drones, radio-controlled toys, and radio-controlled robots, etc., this technology has not been of any practical use in driving vehicles remotely because of numerous control and viewing complexities. The instant invention takes a giant leap in the art of remote operation of vehicles. By digitizing all physical operations including rear, front, and side view mirrors, it is now possible for a remote driver to have complete control of a vehicle including seeing in real time the surroundings, a remote driver can operate a vehicle just as efficiently and effectively as a driver in the vehicle, using the instant invention. Additionally, the remotely operated vehicles may not even have to provide a driver-dedicate seat, increasing the seating capacity of passengers.

The remotely operated vehicles provide a better option to a human driver in the vehicle; long-haul truck driving is subject to driver fatigue, drowsiness of drivers, limited time use of vehicles as the drivers cannot operate continuously, eliminating risk of harm to drivers, providing employment opportunities to millions who are not able to leave home, are disabled to operate, and allow significant cost savings to consumers when using hired vehicles.

Automobile theft remains a major source of insurance losses since, once a culprit can break into a vehicle, it is relatively easy to operate the car by short-circuiting the controls. The instant invention allows a theft-deterrent solution by allowing the driver to remove the screen, inactivating all controls in the vehicle.

The instant invention significantly improves a variety of safety, efficiency and security challenges in a modern vehicle.

No prior art discloses such unanticipated changes to the design of vehicle as disclosed in the instant invention that stands to revolutionize the design of vehicles, their utility in our daily lives with its enormous benefits of safety, security, cost-saving and enhanced business productivity as described in greater detail later.

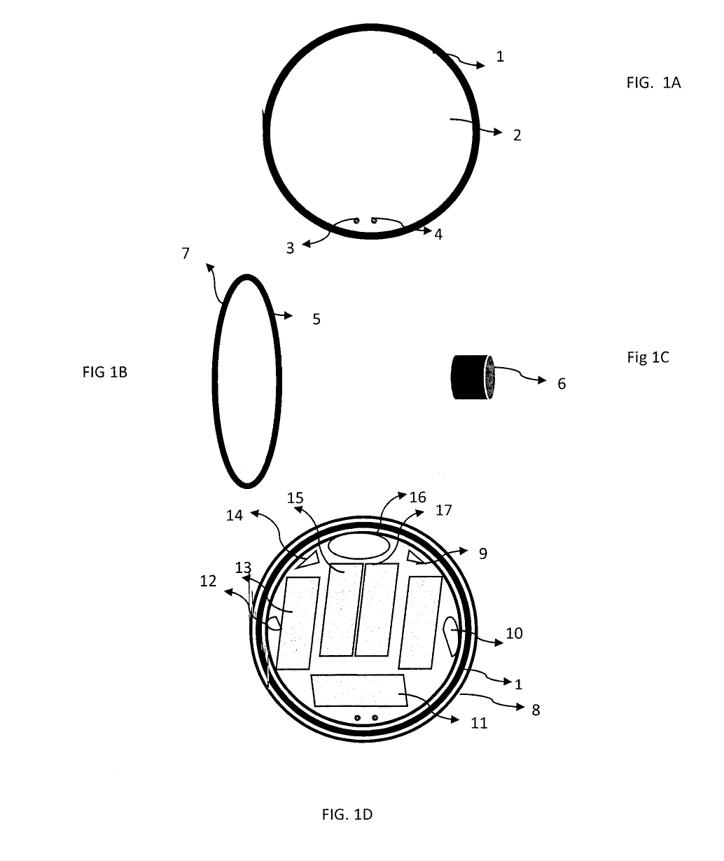

Referring now to the invention in more detail, FIG. 1A is the front view of the front display surface of a touch-sensitive screen (2), a view that will be visible to the vehicle driver showing a circular icon of the steering wheel (1), a camera (3) and a light sensor (4). The front display surface is a light-emitting diode screen (LED), electroluminescent screen (ELD), electronic paper, E Ink, plasma screen panel (PDP), liquid crystal screen (LCD), organic light-emitting diode screen (OLED).

FIG. 1B shows a perspective view of the screen with a back side (5) and the back part of the grip portion. FIG. 1C shows a perspective view of the screen without the grip portion a boss (6) to connect the back support surface to a steering column. The boss may further include a motorized means that connects to the steering wheel wirelessly and helps rotate the boss when the steering wheel is rotated.

FIG. 1D shows a front view of the front display screen facing the driver of the vehicle showing a grip portion (8), turn signals (9 and 14), accelerator (10), a main menu display (11), braking control (12), environment controls (13), left view and left rear view (15), navigation display (16) and right view and rear right view (17). The arrangements shown here are strict as an example, and any permutation and combination, sizes, relative position and drop down menus are within the limitations of the disclosure of the invention.

For drivers with specific handedness, it will be possible to drag and drop the various display icons and controls to either side of the screen for convenience. The primary menu screen can be used to display a variety of controls as the need arises.

While in one embodiment, the invention proposes to consolidate all or majority of functions of the vehicle into a single electronic device. However, the ______ display that can be placed on the screen will include the mileage, speed, cruise set speed, engine rpm, engine temperature, level of fuel, engine malfunction warning, weather condition inside and outside of vehicle, front view, rear view, side view, and a panoramic view of vehicle surrounding, service reminder, tire pressure, state of turning signal, high beam, fuel consumption efficiency, safe lane change warning, air conditioning settings, entertainment system setting, voice control settings, seat setting, driver drowsiness warning, and erratic driving warning.

Among the controls the displays will include opening and closing doors, starting or shutting off engine, accelerating, decelerating and stopping the vehicle, applying parking brake, steering the vehicle, shifting gear, turning wheels, operating wipers, sounding horn, operating entertainment systems, operating air-conditioning, operating the trunk, operating windows, operating door locks, operating child-proof locks, operating headlights and fog lights, setting high or low beam, operating cell phone, operating navigation system, adjusting the panoramic view of the vehicle surroundings, adjusting intensity and color of interior lighting, operating trunk, setting theft alarm, connecting to internet, setting clock, applying parking brakes, selecting comfort setting of suspension, adjusting height of vehicle body, setting position of seat elements, adjusting cooling, heating or ventilation in seats, adjusting seat massaging, lumbar support and side support, operating a garage door, resetting odometers, resetting travel history, setting mode of driving to standard or economy, operating sunroof, operating internet, operating cell phone, connecting with emergency help, operating turn signals, operating emergency flasher, setting cruise control, adjusting brightness of screen, activating safe lane change warning, and scanning and identifying a fingerprint.

The instant invention replaces the conventional steering wheel with a flat touch-sensitive electronic screen that has a similar shape and size as a traditional steering wheel, to simulate standard driving practice and operated similarly to a traditional steering wheel. An optional grip portion is provided at the edge of the device to improve grip. Additionally, an icon of steering wheel along the edge of the front display screen allows for turning the steering column by touching the steering wheel when it is kept stationary.

Over the past century, the vehicle controls have become highly sophisticated resulting continuous growth in the numbers of levers, knobs, buttons, pedals and dials that the driver routinely adjusts or views before starting and during the operate. By integrating a plurality of instrument panels, knobs, dials, buttons, pedals and levers found in modern vehicles to a single electronic display screen and using the screen as a steering wheel significantly improves the safety of vehicle operations. First, by allowing the driver to keep his/her hands on the steering device while controlling a variety of vehicle functions, and second by not needing for the driver to turn his/her face to adjust the controls.

Consolidation of controls of vehicle control as provided in the instant invention had never been considered a possibility because of the multiplicity of input devices currently used including mirrors. Using an electronic steering wheel provides two new opportunities. First, as the screen is self-contained in all its parts, it can be removed from the vehicle making the vehicle totally inoperable as a security measure. Second, by connecting the removed screen through a remote connection, it is now possible to operate a vehicle without being present physically in the vehicle. This innovative step will revolutionize how will we use vehicles in the future.

Remote operation of moving devices is a well known in the art as demonstrated by drones, piloted toy planes, robots and the like. Whereas many experimentations are underway to develop a self-driving vehicle, these experiments are in the infancy stage. When it comes to the safety of human beings, there is no computer that can outperform humans in the operation of vehicles. However, there are times when the presence of a driver in a vehicle may not be practical or advisable. The instant invention, by its basic design, creates a device that makes it possible to safely operate the vehicles from a distance by human drivers with just the same feeling as if they were present inside the vehicle. The reason why such systems were not possible earlier as the prior art bears out, is because the control functions of vehicles are scattered throughout the device; many controls remain mechanical and are not capable of being controlled remotely.

The steering wheel can be installed to meet the right hand and left hand driving vehicles devices without the need for any mechanical modifications to the vehicle. It is even possible for the screen to be operated from anywhere in the vehicle when the screen is connected to cameras that provide a 360-degree view around the vehicle.

To improve the safety further, the front display screen has sensors to adjust its brightness, its contrast mode, light on dark or dark on light, to provide an optimal condition most suitable for safe driving without distracting the driver.

Driver drowsiness detection is a car safety technology which helps prevent accidents caused by the driver getting drowsy. Various studies have suggested that around 20% of all road accidents are fatigue-related. Some of the current systems learn driver patterns and can detect when a driver is becoming drowsy. The systems that monitor driver's face and eye are the head pose estimation that provides key information about driver's activity and awareness. However, to date, no commercial vehicle has provided this functionality mainly because of inability to dispose of a camera in a position where it can accurately monitor face movement and more particularly the eye movement. It is now recognized that long before the head movement becomes relevant, the eye movement, more particularly the blinking of eyes begins to show signs of drowsiness. The instant invention provides this advanced feature never used before in any vehicle. The camera facing the driver and embedded in the screen in the instant invention introduces identification of situations where the driver may be getting drowsy much earlier than any other method currently used.

The shape and size of the screen can vary, the circular or semi-circular being the most desirable; however, there may be reasons to use rectangular screens.

In one embodiment, the instant invention brings controls closest to the eyes of the vehicle driver making them easily readable.

In another embodiment, the instant invention improves the visibility of the surroundings of a vehicle by using highly sensitive cameras.

In another embodiment, the instant invention consolidates all or majority of control functions into a single screen in front of the vehicle driver avoids turning head to view the operational conditions of the vehicle.

In another embodiment, the instant invention by using a touch-sensitive screen enables the driver to control operations of vehicle without lifting hands off the steering device

In another embodiment, the instant invention provides an 180 or 360 degrees' panoramic view using cameras more capable than human eye to detect hazards and improve safety.

In another embodiment, the instant invention by allowing the steering device to be removed by the owner of the vehicle introduces a security measure by making the vehicle inoperable.

In another embodiment, the instant invention allows removal of most of the knobs, dials, levers, buttons, and levers necessary to operate the vehicle.

In another embodiment, the instant invention makes the vehicle inoperable upon removing the screen to make it theft-proof.

In another embodiment, the instant invention improves comfort to the driver by providing controls at a preferred position.

In another embodiment, the instant invention allows remote operation of the vehicle by removing the screen and manipulating it from a distance.

Those familiar with the art of vehicle instrumental screens, and more particularly digital screens such as graphical user interfaces, will agree that the consolidation of hundreds of functions into a menu-driven screen that is controlled by screen function is a significant advancement of technology.

All references, including publications, patent applications, and patents, cited herein are at this moment incorporated by reference to the same extent as if each reference were individually and specifically indicated to be incorporated by reference and were outlined in its entirety herein.

The use of the terms “a” and “an” and “the” and similar referents in the context of describing the invention (especially in the context of the following claims) are to be construed to cover both the singular and the plural unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein is merely intended to serve as a shorthand method of referring individually to each separate value falling within the range unless otherwise indicated herein, and each separate value is incorporated into the specification as if it were individually recited herein. All methods described herein can be performed in any suitable order unless otherwise indicated herein or otherwise clearly contradicted by context. The use of all examples, or exemplary language (e.g., “such as”) provided herein, is intended merely to illuminate better the invention and does not pose a limitation on the scope of the invention unless otherwise claimed. No language in the specification should be construed as indicating any non-claimed element as essential to the practice of the invention.

What is claimed is:

1. A Vehicle Steering and Control Device (VSCD) comprising:
a steering wheel comprising a flat touch-sensitive electronic screen with at least one edge, a front display surface, a back support surface and a plurality of inputs;
a boss connecting the back support surface to a steering column;
a graphic user interface (GUI) comprising the said flat touch-sensitive electronic screen further comprising a vehicle computer, communicating with the flat touch-sensitive electronic screen, directly or wirelessly, configured to receive user input defining user instructions by touching the surface of the flat touch-sensitive electronic screen for controlling a plurality of vehicle functions and displaying operational conditions of the vehicle on the front display surface of the flat touch-sensitive electronic screen.

2. The VCSD of claim 1, wherein the flat touch-sensitive electronic screen is round, oval, square or rectangular in shape.

3. The VCSD of claim 1, wherein a trim is disposed of surrounding the edge of the flat touch-sensitive electronic screen;

4. The VCSD of claim 1, wherein the GUI further comprises means to keep the display on the front display surface horizontally aligned when the steering wheel is rotated.

5. The VCSD of claim 1, wherein the boss further comprises a motor to rotate the boss upon receiving an electronic signal.

6. The VCSD of claim 5, wherein the steering wheel remains stationary and connects to the steering column through the motorized boss by hard wire or by a wireless means, in response to touching an icon of a steering wheel displayed on the front surface.

7. The VSCD of claim 1, wherein the steering wheel is removable and removed from a vehicle to render the vehicle inoperable or to operate the vehicle remotely by connecting the steering wheel wirelessly to the vehicle computer.

8. The VSCD of claim 1, wherein the flat touch-sensitive electronic screen is a light-emitting diode screen (LED), an electroluminescent screen (ELD), plasma screen panel (PDP), a liquid crystal screen (LCD), an E-ink screen or an organic light-emitting diode screen (OLED).

9. The VCSD of claim 1, wherein the flat touch-sensitive electronic screen is disposed with means of recognizing a driver and allow operation of the vehicle, comprising a fingerprint reader and/or a camera capable of recognizing a face, based on previously recorded images.

10. The VCSD of claim 1, wherein a camera is disposed of on the front display surface continuously monitors changes in the face movement and/or changes in the frequency of eye blinking as early signs of drowsiness and triggers a warning to the driver.

11. The VCSD of claim 1, wherein the flat touch-sensitive electronic screen further comprises a light sensor capable of sensing the light falling on the front display screen and adjust the brightness and contrast of the front display screen to preset levels.

12. The VCSD of claim 1, wherein a plurality of cameras sensitive to visible and infrared radiation are disposed of in the front, rear and side of the vehicle to display a panoramic 180 or 360-degree view of the surroundings of the vehicle on the front display surface.

13. The VSCD of claim 1, wherein the vehicle operational conditions displayed on the front display surface include but not limited to miles driven, speed, cruise set speed, engine rpm, engine temperature, level of fuel, engine malfunction warning, weather condition inside and/or outside of vehicle, front view, rear view, side view, and panoramic view of vehicle surroundings, service reminders, tire pressure, state of turning signal, emergency flasher, high beam setting, fuel consumption efficiency, safe lane change warning, air conditioning settings, entertainment system setting, voice control settings, seat setting, driver drowsiness warning, and erratic driving warning.

14. The VSCD of claim 1, wherein the controls operated by touching the front display surface include but not limited to recognizing the driver, opening and closing doors, starting or shutting off engine, accelerating, decelerating and stopping the vehicle, applying parking brake, steering the vehicle, shifting gear, turning wheels, operating wipers, sounding horn, operating entertainment systems, operating air-conditioning, operating the trunk, operating windows, operating door locks, setting child-proof locks, operating headlights and fog lights, setting high or low beam, operating cell phone, operating navigation system, adjusting the panoramic view of the vehicle surroundings, adjusting intensity and color of interior lighting, operating trunk, setting theft alarm, connecting to internet, setting clock, applying parking brakes, selecting comfort setting of suspension, adjusting height of vehicle body, setting position of seat elements, adjusting cooling, heating or ventilation in seats, adjusting seat massaging, lumbar support and side support, operating a garage door, resetting trip odometers, resetting travel history, setting mode of driving to standard or economy or sports and normal, operating sunroof, operating internet, operating cell phone, connecting with emergency help, operating turn signals, operating emergency flasher, setting cruise control, setting adaptive cruise control settings, adjusting brightness of screen, activating safe lane change warning, and scanning and identifying a fingerprint to permit operation of vehicle.
